(19) United States
(12) Patent Application Publication
(10) Pub. No.: US 2013/0199081 A1
(43) Pub. Date: Aug. 8, 2013

(54) ARTIFICIAL FISHING LURE

(71) Applicants: Mark Hepp, Nanaimo, BC (CA); Scott Leesing, Nanoose Bay, BC (CA)

(72) Inventors: Mark Hepp, Nanaimo, BC (CA); Scott Leesing, Nanoose Bay, BC (CA)

(21) Appl. No.: 13/761,699

(22) Filed: Feb. 7, 2013

Related U.S. Application Data
(60) Provisional application No. 61/595,797, filed on Feb. 7, 2012.

(51) Int. Cl. A01K 85/00

(52) U.S. Cl. CPC A01K 85/00
USPC 43/43.13

(57) ABSTRACT

An artificial fishing lure for use in trolling. The lure has a body with a leading edge, a tail, a top surface, a bottom edge, a first side and a second side. At least three line passages are positioned in spaced relation along the top edge between the leading edge and the tail; including a lead line passage, a mid-body line passage, a knot hole line passage. A holding clip is positioned on the second side of the body next to the knot hole passage. The holding clip is adapted to maintain a shank of a hook in friction fit engagement with the hook generally oriented toward the tail when casting or trolling. The clip releases the hook from the body when a fish strikes. The body holds its position on the line when the line is taut due to friction resulting from the manner the line is woven through lead line passage, the mid-body line passage and the knot hole line passage.

### FIELD

There is described a one piece fish lure with a releasable hook positioned on the body of the lure.

### BACKGROUND

There is much prior art in the field of artificial fish lures, with many different designs and made of various materials. Most artificial fishing lures strive to imitate a food source for a predatory fish. There is much prior art, in respect to artificial lures and their respective actions. Most lures that are designed to create their own action, either wobble, wiggle, or flutter from side. These actions are designed to simulate a crippled or swimming bait fish action. The degree of success is varied with these lures. In general, they have very little motion of their own. To give or enhance motion, they are trolled behind flashers or dodgers, or retrieved in an inconsistent fashion.

Natural lures, being processed natural bait fish, are still widely used, particularly in trolling for predatory fish. For example, whole anchovy or herring have hooks directly embedded in them with the fishing line passing through an artificial teaser head which is affixed to the bait fish, usually with a toothpick. The teaser heads are angled or finned to give the bait a rolling type of action as it's trolled through the water. Another natural bait presentation, is in the form of a cut plug, which is a herring, with the head cut off at an angle and bevel, with the hooks arrangement, one hook in the top leading edge and another hook in the side rear body. This produces the action, which is a particular rolling presentation, to simulate a crippled bait fish.

Although still widely used, natural bait fish have some disadvantages. The bait fish has to be kept on ice or frozen and has a short shelf life. The bait degrades in use and must be changed often, so a good supply of bait must be available, which can be costly.

Predatory fish are attracted to a particular action when using bait, which is best described as a rolling corkscrew, with the tail section of said bait having a relatively tight radius. The pulsating flashes rolling bait creates, triggers a natural response for predatory fish feeding on their prey. Predatory fish, are more inclined to strike crippled or wounded bait fish as they are easy prey. The pulsating flashes and rolling motion also irritates and aggravates non-feeding, fish into striking. Although scent and sound are factors attracting predatory fish, the primary stimuli is sight. Therefore, the swimming action as the bait is drawn through the water is the key attractant, combined with the colors, and reflective properties.

Most fishing lures imitate a food source for a predatory fish. In general, they have very little motion of their own. To give them motion, they are trolled behind a flasher or dodger. Lures that are designed to create their own action either wobble, wiggle or flutter from side to side.

There is also prior art in regards to artificial fishing lures in respect to hook positioning and said hook to be releasable from the lure, at which time the lure has the capability to slide up the leader line while playing a fish. We have found that most strikes occur on the rearward portion of the lure body. Free movement of the hook in that position can have an effect on the performance of the lure in regards to the action as it's drawn through the water. Free movement of the hook can also lessen the chances of hooking the fish when it strikes.

Some lures are designed to allow the hook to detach or slide free of a lure when a fish is hooked. This is beneficial when the fisherman is playing said fish in that the lure doesn't affect the playing of the fish, interfere with the netting of the fish or interfere with bringing the fish on board. However, to be a beneficial feature, the lure needs to be able to slide up the line when a hooked fish runs.

### SUMMARY OF THE INVENTION

There is provided an artificial fishing lure which includes an elongated body emulating in profile a bait fish. The body has a leading edge, a tail, a top edge, a bottom edge, a first side and a second side. At least three line passages are positioned in spaced relation along the top edge between the leading edge and the tail; including a lead line passage, a mid-body line passage, a knot hole line passage. A clip is positioned on the second side of the body next to the knot hole passage. The clip is adapted to maintain a shank of a hook in friction fit engagement with the shank oriented toward the leading edge and the hook generally oriented toward the tail, and the hook tip pointing forward, when casting or trolling. The clip releases the hook from the body when a fish strikes. When the hook releases; water pressure and resistance force the lure to travel up the line. The body holds its position on the line when the line is taut due to friction resulting from the manner the line is woven through lead line passage, the mid-body line passage and the knot hole line passage.

Although beneficial results may be obtained through the use of the artificial fishing lure, as described above, it has been determined that greater “hold” is achieved for the line when the lead line passage has a line entry point in the top edge spaced from the leading edge and a line exit point in one of the first side and the second side. The entry through the top edge contributes greatly to the increased holding ability. It is, of course, undesirable for the body to move back toward the hook where it can interfere with landing and netting of the fish.

The lure can be made in different sizes to resemble different bait fish. The shape of the body can vary depending upon the bait fish one is attempting to emulate. Beneficial results have been obtained from a profile in wherein the top edge is convex, the bottom edge is convex, the first side is convex and the second side is concave.

The number of line passages can vary. However, beneficial results have been obtained using three, being, a lead line passage, a mid-body line passage and knot line passage. The lead line passage is in proximity to the leading edge and the convex top edge, the lead line passage having a line entry point in the convex top edge spaced from the leading edge and a line exit point in concave side. The mid-body line passage is mid-body of the body in proximity to the convex top edge, the mid-body line passage having a line entry point in the concave side and a line exit point in the convex side. The knot hole passage is in proximity to the tail and the convex top edge, the knot hole passage having a line entry point in the convex side and a line exit point in the concave side.

The artificial fishing lure described above has a body that is attractive in appearance and action to a variety of predatory game fish and trigger a response from them. The hook is affixed to the lure body by means of a holding clip, within the confines of the lure body. The lure has the capability to move up the line, once the hook is released when playing a fish. There is not much movement due to friction caused by the line passages and movement only occurs when the line is not taut. As described above, the body holds its position on the line when the line is taut due to friction resulting from the manner in which the line is woven through lead line passage, the mid-body line passage and the knot hole line passage.

This invention relates to artificial fishing lures particularly for trolling. The lure has a complex action as it is drawn through the water that is intended to emulate a swimming or wounded bait fish. It is of a one-component design, and includes a clip positioned on the body of the lure for holding a fishing hook during trolling and releasing the hook when a fish takes the hook.

The subject invention is an artificial fishing lure primarily for trolling. This lure is configured to provide a rolling corkscrewing/spiraling action on its own as it's trolled through the water; which is a desired action, particularly when fishing for predatory fish. This design can be used successfully without flashers and dodgers or in conjunction with them. On a slower troll, this design gives the appearance of a crippled bait fish, while on a faster troll it emulates that of a swimming bait fish. A single hook is utilized within the confines of the body, in which the eye of the hook is held flat against the body by a unique series of holes, while the shank of the hook is held to the body with a releasable clip. A hooked, fighting fish will pull the hook from the clip, allowing the lure to slide up the leader line when it runs. The arrangement of holes through which the fishing line is strung and friction allows the lure to remain in place, without sliding back down the line as the playing of the fish continues.

The motion or action of the lure derived from the invention makes the lure appear to swim. The lure rotates along a corkscrew path similar to a stretched out spring. Each rotation of the lure creates two separate and distinct actions. (1) a corkscrewing motion, (2) a spiraling motion caused by an off set center of balance designed with the head and tail section being sized and weighted differently. The lure spirals continuously with a larger orbit for the tail and a smaller orbit for the head, creating a rocking motion. The travel of the lure (speed it is trolled at) when it is trolled is slow, relative to the quick spinning motion created by the design. This motion irritates and aggravates both feeding and non-feeding predatory fish into striking. The second is a pulsating oscillation. The lure travels slowly and creates a pulsating flash-flash-flash. (variable speed oscillation). This pulsating flash, combined with a visual stimulant (light reflective qualities of the finish and color) triggers a strike. Predatory fish are attracted to these flashes as a natural response to feeding on their prey, or snapping at them as an irritant when they are mature. Our design mimics a swimming and/or crippled bait fish. The above actions are intended to create a motion similar to a bait fish attempting to get away from a predator.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a top plan view of an artificial fish lure embodiment of the present invention with internal passages indicated by dashed lines.

FIG. 2 is a side elevation view of a concave side of the artificial fish lure of FIG. 1.

FIG. 3 is a bottom plan view of a concave side of the artificial fish lure of FIG. 1.

FIG. 4 is a side elevation view of a convex side of the artificial fish lure of FIG. 1 with the fish lure shown as if it had been rotated 180 degrees as compared to the side-elevation view in FIG. 2.

FIG. 5 is a front elevation view of a concave side of the artificial fish lure of FIG. 1.

FIG. 6 is a rear elevation view of a concave side of the artificial fish lure of FIG. 1.

FIG. 7 is a side elevation view of a concave side of the artificial fish lure of FIG. 1, with cross sections shown as FIGS. 7a, 7b, 7c, 7d, 7e.

FIG. 8 is a top plan view of the artificial fish lure of FIG. 1, shown rigged with hook and line, showing the line within the internal passages, the latter indicated by dashed lines.

FIG. 9 is a side elevation view of a concave side of the artificial fish lure of FIG. 2, shown rigged with hook and line.

FIG. 10 is a bottom plan view section of a concave side of the artificial fish lure of FIG. 3, shown rigged with hook and line, showing the line within the internal passages, the latter indicated by dashed lines.

FIG. 11 is a side elevation view of a convex side of the artificial fish lure of FIG. 4, shown rigged with hook and line.

FIG. 12 is a side elevation view of a concave side of the artificial fish lure of FIG. 2, showing an area of enlargement.

FIG. 12a is an enlarged perspective cross section view of a tail section of the artificial fish lure of FIG. 12 at the hook clip.

FIG. 12b is an enlarged perspective cross section view of a tail section of the artificial fish lure of FIG. 12 at the hook clip, shown with hook in position.

FIG. 13 is a perspective view indicating the orbits of the rolling/orbiting action, the direction of the action and the radius of the actions at various points in relation to each other.

FIG. 14 is a top plan view of the artificial fish lure, shown rigged with hook and line, showing the direction of pull and angle of attack.

FIG. 15 is a stylized representation of the action of the artificial lure as it is drawn through the water, showing the lure in five sequential positions, going from right to left in the figure, with lines indicating the trajectory of features of the lure intermediate the five sequential positions.

### DETAILED DESCRIPTION

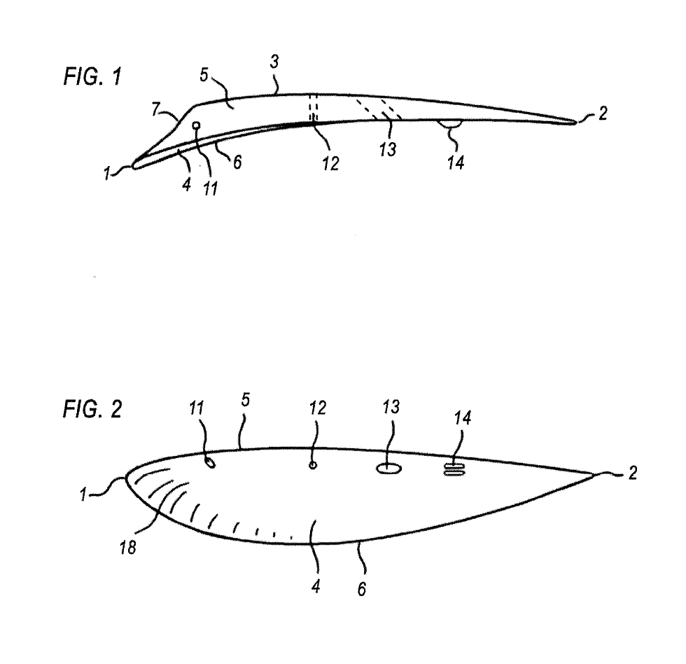

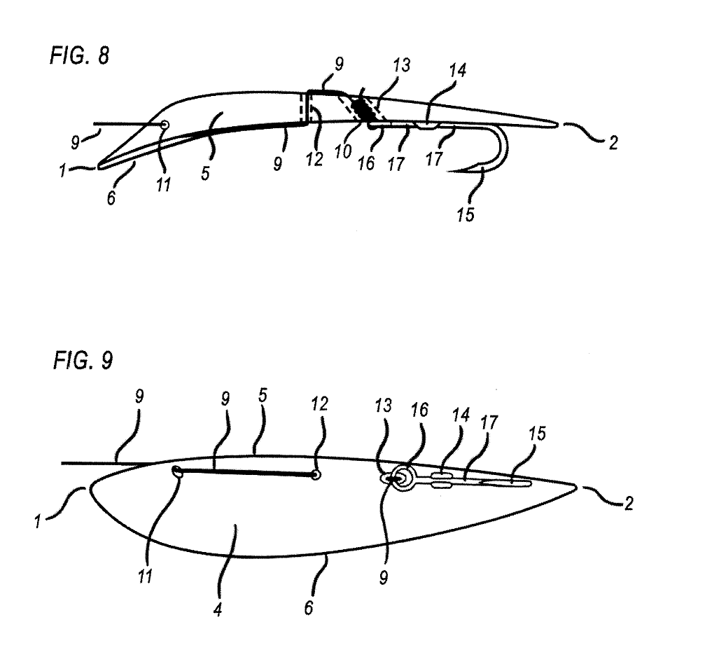

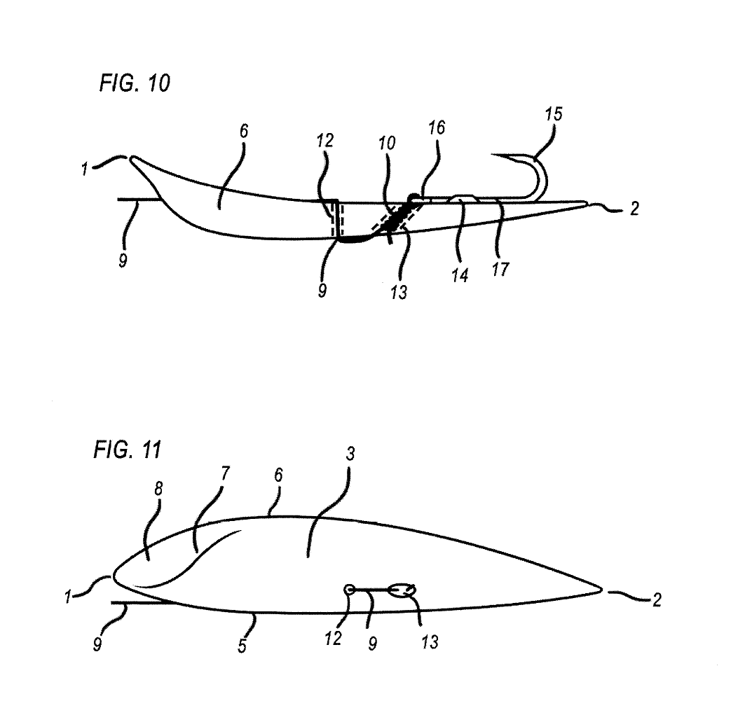

An artificial fishing lure embodiment of the present invention is hereafter described with reference to FIG. 1 through FIG. 15. The following reference numbers and descriptive terms are used herein and in the drawings.
1. lead edge
2. tail
3. outside (convex side)
4. inside (flat/concave side)
5. top surface (spine)
6. bottom edge
7. cant and bevel (head area)
8. spade shape semi vertical plane
9. fishing line
10. fisherman's knot
11. lead hole (where fishing line exits the lure)
12. mid body hole
13. knot hole
14. hook holding clip
15. hook
16. eye of the hook
17. shank of the hook
18. concave area on the flat side of the lure
19. bottom edge roll orbit
20. tail roll orbit
21. fishing line orbit
22. direction of travel
23. direction of angle of attack
24. forward face
25. shank seat
26. retention slot
27. straight path
30. bottom edge trajectory
31. top surface trajectory

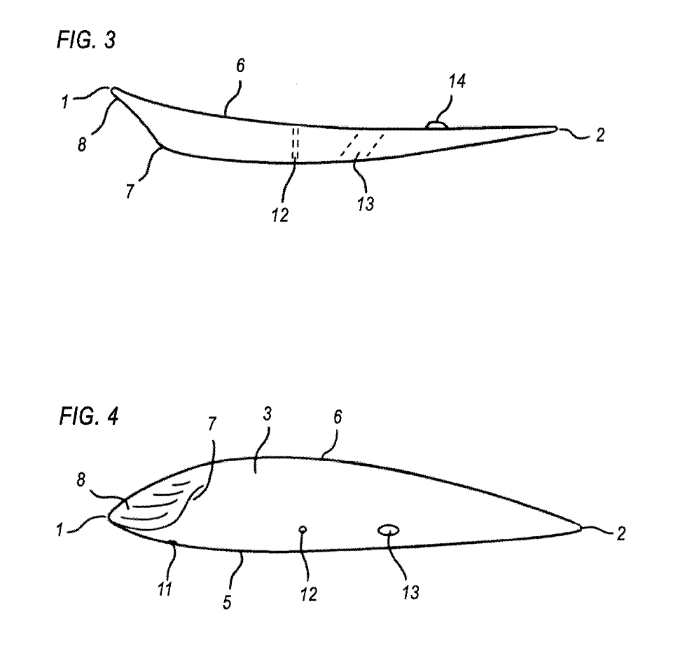

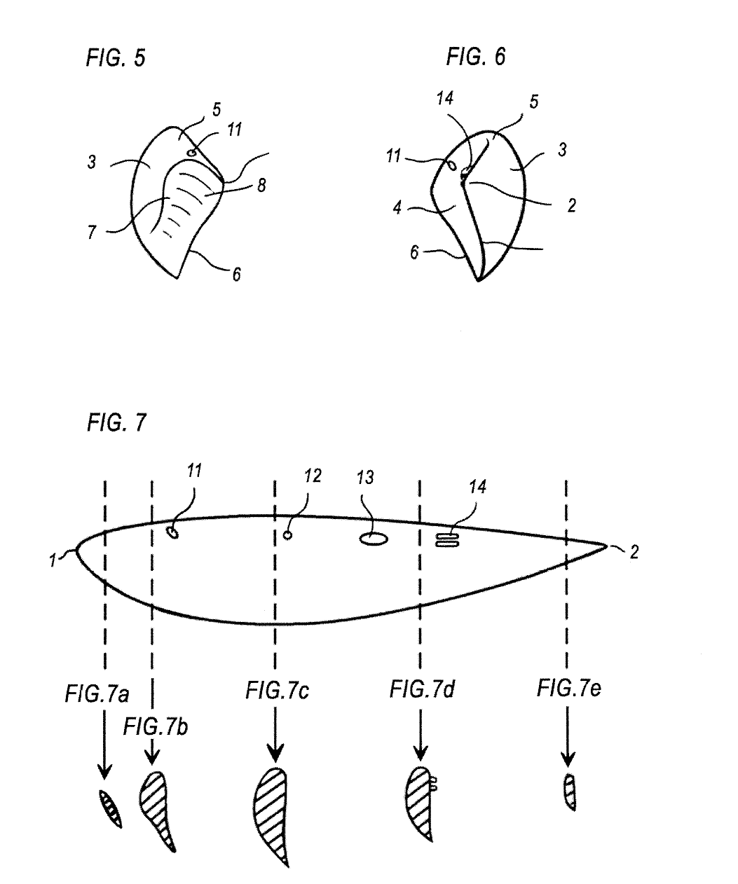

Body design: With reference to FIG. 3 and FIG. 5, the embodiment has the general outline of a bait fish. Acutely pointed tail 2, with a slight convex longitudinal curve along the top surface 5 from the tail 2 to an area at the lead hole 11, where the curve increases to form a rounded point at the lead edge 1. From the tail 2, the bottom edge 6 has a greater convex curve than the top surface 5, allowing the depth of the body to widen, to where the curve increases starting just rearward of the lead hole area 11, to join with the rounded point at the lead edge 1.

One side, the outside 3 is relatively full bodied and rounded (convex), while the other side, the inside 4 is relatively flat with the front and lower section being slightly concave, as indicated in FIG. 7. FIGS. 7a, 7b, 7c, 7d, 7e showing the shape and the thickness of the embodiment at the indicated positions along its length.

FIG. 1 is a top plan view of the embodiment. There is a slight longitudinal bend convex to the outside 3. On the top of the inside 4, there is a slight bend from the tail 2 to the vicinity of the knot hole 13, where the bend gradually increases to the lead edge 1. The top surface 5 is rounded. The embodiment is narrow and acute in the vicinity of the tail 2, and thickening towards the vicinity of the lead hole 11. On the outside 3 from the tail 2, to the vicinity of the lead hole 11, the longitudinal bend is slight. In the vicinity of the lead hole 11, the bend increases, then reverses to meet up with the edge of the inside 4 at the lead edge 1. The bottom edge 6, is an acute edge from the lead edge 1, to the tail 2.

FIG. 2 is a side elevation view of the inside 4. From the vicinity of the lead hole 11, back towards the tail 2, the inside 4 is substantially planar, with only the bottom edge 6 being curved where it blends into the inside 4 at the hook holding clip 14 and remains substantially planar to the tail 2. Forward of the lead hole 11, the concave area along the bottom edge 6, blends into the longitudinal bend on the inside 4.

FIG. 3 is a bottom plan view. The curve of the bottom edge 6 is the same arc as the outside 3, narrow at the tail 2 and gradually widening towards the front where the bend in the curve increases to the lead edge 1.

FIG. 4 is an elevation view of the outside 3. The outside 3, is slightly rounded in the vicinity of the tail 2, becoming increasingly rounded and thick forward from the vicinity of the tail 2 through to the vicinity of the lead hole 11. In the vicinity of the lead hole 11 there is a rounded cant and bevel 7, sloping in and up from just above the bottom edge 6 so as to provide to this portion of the outside 3, a spade shape semi vertical plan 8. The cant and bevel 7, is well-defined in the vicinity of the top surface 5 and decreases and smoothens into a general curvature in the vicinity of the bottom edge 6.

FIG. 5 is a front view showing the cant and bevel 7, the spade shape semi vertical plane 8, lead hole 11, and bottom edge 6.

FIG. 6 is a rear view, also indicating the curves and bends.

Fishing line holes and hook clip: The described embodiment incorporates three holes through which a fishing line 9 is strung so as to secures the lure to the fishing line 9 and to which the hook 15 is tied, as indicated in various of FIGS. 1 through 11. The holes are spaced apart one from the other longitudinally, adjacent the top surface 5. The knot hole 13 is positioned approximately two thirds back towards the tail 2. The knot hole 13 has a diameter large enough to accommodate, and to slide freely with respect to, the fisherman's knot 10, which a fisherman generally uses to tie the fishing line 9 to the hook 15. From the inside 4, the knot hole 13 is angled forward toward the outside 3. Forward of the knot hole 13, the mid body hole 12 is positioned. The mid body hole 12 extends generally transverse to the longitudinal extent of the lure, between the outside 3 and the inside 4. The mid body hole 12 is sized to allow the fishing line 9 to slide freely. The third hole, the lead hole 11, extends forward and up, relative to a direction transverse to the longitudinal extent of the lure, between the inside 4 and the outside 3 adjacent the cant and bevel 7. The lead hole 11 is large enough to allow the fishing line 9 to slide freely.

As indicated in the figures, the lead hole 11, mid body hole 12 and the knot hole 13 are substantially aligned.

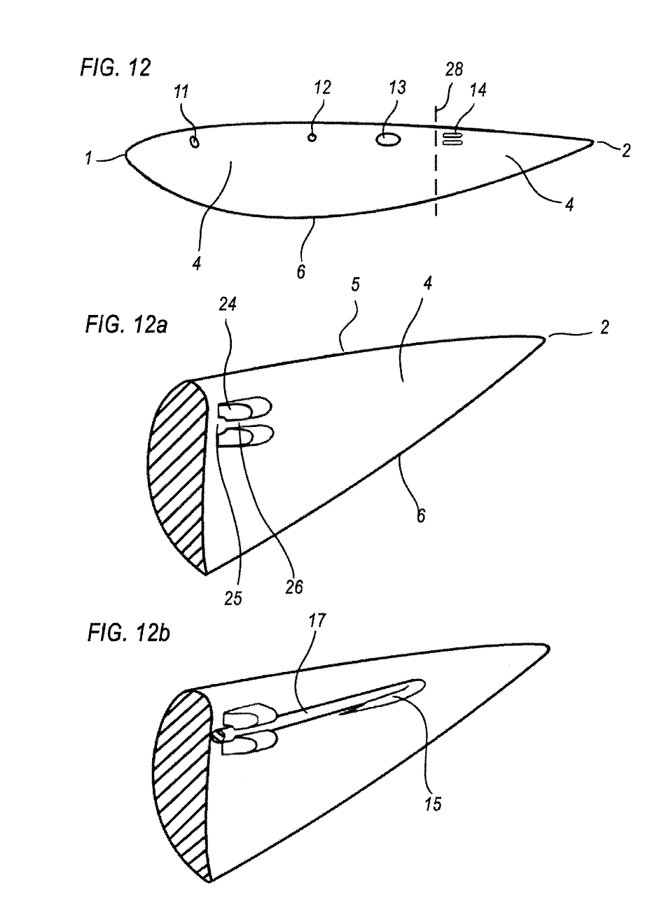

The hook holding clip 14 is positioned on the inside 4, aligned longitudinally with the holes 11, 12, 13 and is positioned just rearward of the knot hole 13, as indicated in FIGS. 12a and 12b. The hook holding clip 12 has a forward face 24 that slopes rearward so as to facilitate release of the hook 15 when a fish strikes in that as the hook 15 is drawn rearward the eye of the hook 16 abuts and moves along the sloped forward face 24, thus lifting the eye of the hook 16 away from the inside 4. The hook holding clip 14 defines a shank seat 25 in which the shank of the hook 17 resides when the embodiment is set up for use, and a retention slot 26, having a width narrower than the diameter of the shank of the hook 17, through which the shank of the hook 17 passes when the hook 15 is installed or released.

Hook and line arrangement. When setting up the embodiment for use, the fishing line 9 is tied to the eye of a hook 16, by means of a fisherman's knot 10. The fishing line 9 is then pulled through the knot hole 13 from the inside 4 to the outside 3, whereby the knot 10 rests within the knot hole 13. This positions the eye of the hook 16 flush to the inside 4 and orients the hook 15 for positioning the shank of the hook 17 in the hook holding clip 14. The fishing line 9 is then strung through the mid body hole 12 from the outside 3 to the inside 4, leaving a short amount of fishing line 9 running along the outside 3 from the knot hole 13 to the mid body hole 12. The fishing line 9 projecting from the inside 4 at the mid body hole 12 is then strung through the lead hole 11, whereby a portion of the fishing line 9 lays along the inside 4 between the mid body hole 12 and the lead hole 11. The fishing line 9 enters the lead hole 11 from the inside surface 4 and exiting slightly forward on the top surface 5. The hook 15 is clipped to the hook holding clip 14.

The hook holding clip 14 is configured to hold the hook 15, flush to the inside 4 and generally longitudinally aligned so as not to impede the action of the lure and positioned where most fish strikes occur. The sizing of the hook holding clip 14 is such that the hook 15 is held snug, to stay in position while the lure is being pulled through the water, yet be able to allow the hook 15 to be disengaged from the hook holding clip 14, upon a strike from a fish.

This configuration of the holes 11, 12, 13 and the manner in which the fishing line is strung through the holes 11, 12, 13 connects the fishing line 9, hook 15, and lure in such a way that the lure can be trolled through the water, as well as allowing the lure to have the ability to slide up the fishing line when a fish strikes and fights, and stay up the fishing line once it has done so.

Action: The complex configuration of the described embodiment with respect to its shape, the means of attaching the hook 15 and fishing line 9 to the lure and hook placement, cause the lure to have a desirable spiraling and corkscrew action when it is trolled through the water, which can be described as a corkscrew rolling action with a variable speed within the roll. Due to the fishing line 9 exiting at the lead hole 11, which is behind and above the spade shape semi vertical plane 8, the lure has a slight angle of attack as it is trolled through the water.

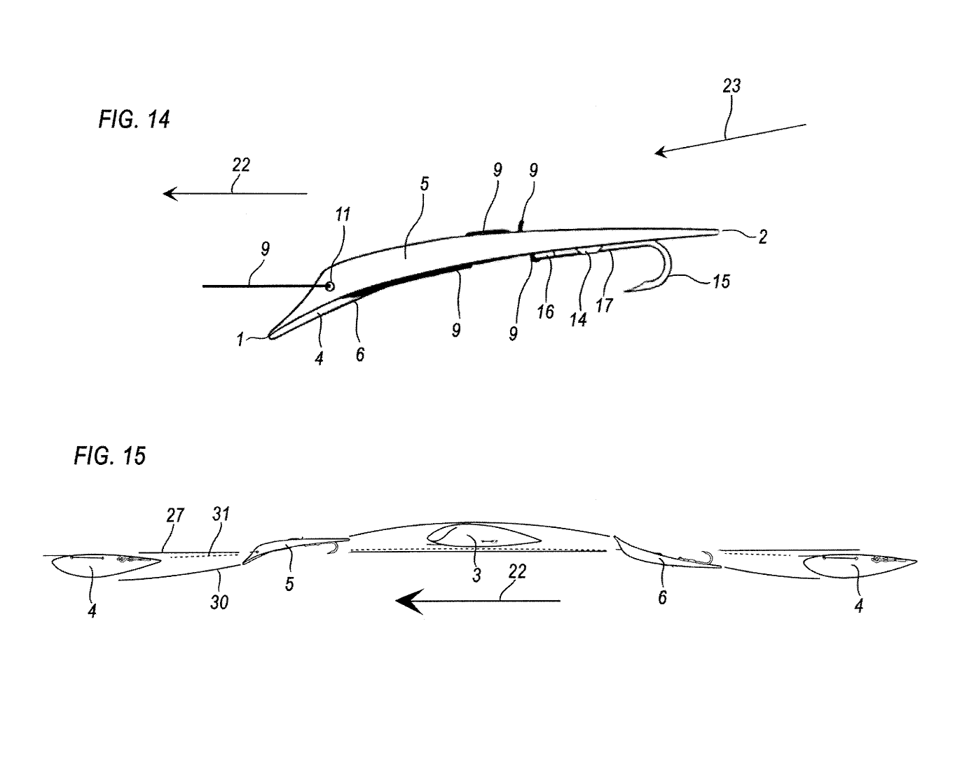

As indicated in FIG. 14, the direction of travel 22 and the direction of the angle of attack 23 are not parallel.

In use, when trolling, the water resistance at the spade shape semi vertical plane 8 pulls the lure at an angle, and along with the water resistance caused by the cant and bevel 7, initiates a rolling action. Being unbalanced with most of the thickness and mass being generally in the vicinity of top surface 5 and forward, along with the rounded convex shape of the outside 3, the bottom edge 6 being acute, and the inside 4 being generally planar and curved, allows the bottom edge 6 to roll around an off set axis at the point where the fishing line 9 exits at the lead hole 11.

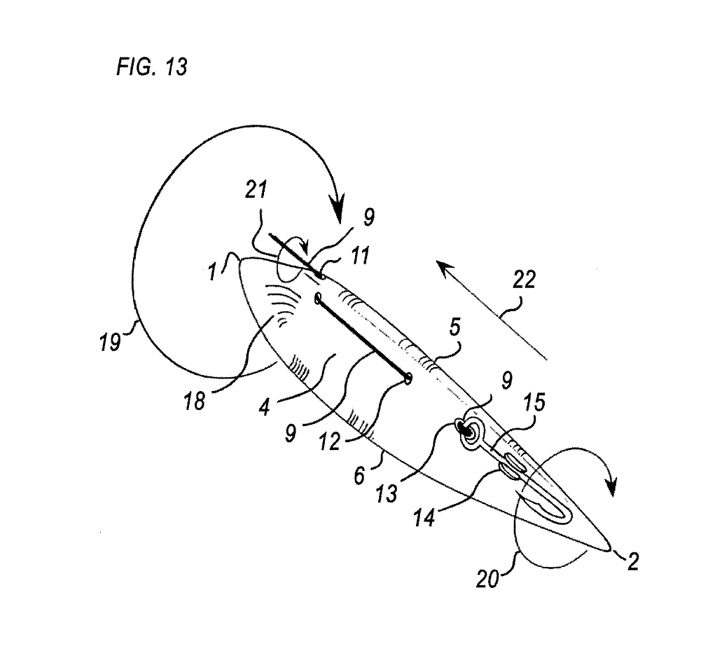

The angle of the lure and the rolling action as it is pulled through the water causes the fishing line 9 just forward of the exit point at the lead hole 11, to have a small orbit, being the fishing line orbit 21 indicated in FIG. 13.

FIG. 13 also indicates the bottom edge roll orbit 19 and the tail roll orbit 20, and the relationship with respect to the relative sizes of the radii of the orbits 19, 20, 21. The radius of the tail roll orbit 20 is desirably kept relatively tight due to the slight longitudinal bend in the body of the lure.

FIG. 15 shows the embodiment as it is drawn through the water, showing the lure in five sequential positions, going from right to left in the figure as indicated by the direction of travel 22. FIG. 15 schematically represents a straight path 27, and the bottom edge trajectory 30 and top surface trajectory 31.

The variable speed within the roll occurs when trolling at a slow speed and is more evident on the larger size lures being 7 and 9 inch. The roll of the lure is slower for the bottom edge 6 to roll to the top due to the unbalance of the weight, where the thicker part of the body of the lure being in front at the bevel and cant 7 and the top surface 5 including the weight of the hook 15. As the roll continues to completion the weight of the thick areas allows the lure to flip over and roll quickly.

The method of manufacture may be plastic injection molding. Among other benefits, manufacture by this means permits variations for color and finishes to be applied by paint, dye or mylar tapes. Alternatively, the method of manufacture may be by additive manufacturing (also referred to as 3D printing) which, in addition to the benefits associated with injection molding, also readily permits variations in size. It will be apparent to persons skilled in the art that other methods of manufacturing products of the same general class could also be employed.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. An artificial fishing lure for use with a fishing line and fish hook, the artificial fishing lure comprising:
an elongated body emulating in profile a bait fish, the body having a leading edge, a tail, a top edge, a bottom edge, a first side and a second side, the body being unbalanced with greater mass along the top edge with tapering toward the bottom edge and greater mass along the leading edge with tapering toward the tail, each of the leading edge, top edge and bottom edge having a cant and bevel, the leading edge having a flat spade angled from the second side to the first side and merging into the cant and bevel;
a lead line passage, a mid-body line passage, a knot hole line passage positioned in spaced relationship adjacent the top edge between the leading edge and the tail, for receiving a fishing line when in use; and
a clip positioned on the second side of the body adjacent the knot hole passage, the clip adapted to maintain a shank of a fish hook in friction fit engagement when trolling and to release the hook when a fish strikes,
wherein, in use, the body tends to hold its position on a fishing line when the fishing line is taut due to friction resulting from the fishing line passing through the lead line passage, the mid-body line passage and the knot hole line passage.

2. The artificial fishing lure of claim 1, wherein the lead line passage has a line entry point in the top edge spaced from the leading edge and a line exit point in one of the first side and the second side.

3. The artificial fishing lure of claim 1, wherein the top edge is convex.

4. The artificial fishing lure of claim 1, wherein the bottom edge is convex.

5. The artificial fishing lure of claim 1, wherein the first side is convex and the second side is concave.

6. The artificial fishing lure of claim 1 wherein the top edge is convex, the first side is convex and the second side is concave.

7. The artificial fishing lure of claim 6, wherein
the lead line passage is in proximity to the leading edge and the convex top edge, the lead line passage having a line entry point in the convex top edge spaced from the leading edge and a line exit point in concave side;
the mid-body line passage is mid-body of the body in proximity to the convex top edge, the mid-body line passage having a line entry point in the concave side and a line exit point in the convex side; and
the knot hole passage is in proximity to the tail and the convex top edge, the knot hole passage having a line entry point in the convex side and a line exit point in the concave side.
